(19) United States
(12) Patent Application Publication
(10) Pub. No.: US 2004/0228696 A1
(43) Pub. Date: Nov. 18, 2004

(54) Copying apparatus

(76) Inventor: Terry John Claydon, Bristol (GB)

Correspondence Address: STITES & HARBISON PLLC, 1199 NORTH FAIRFAX STREET, SUITE 900, ALEXANDRIA, VA, 22314, US

(21) Appl. No.: 10/466,426

(22) PCT Filed: May 23, 2001
(86) PCT No.: PCT/GB01/02290

(30) Foreign Application Priority Data
Jan. 16, 2001 (GB) 0101092.5

(51) Int. Cl. B23C 1/16

(52) U.S. Cl. 409/93; 409/97; 409/175

(57) ABSTRACT

Apparatus for enabling a tool (5) to reproduce a pattern from a template (11) on a workpiece (9), the apparatus comprising a first support mechanism (1) which supports the tool (5) in a spaced relationship with a pattern follower (7), a second support mechanism (3) which supports the template (11) and the workpiece (9) in a spaced relationship which one another, the first and second support mechanisms (1, 3) being brought together in use such that the pattern follower (7) overlies the pattern on the template (11) and the tool (5) overlies the workpiece (9), wherein the first support mechanism (1) and the second support mechanism (3) are not connected to one another. The movement of the pattern follower (7) as it follows the pattern on the template (11) produces an identical movement of the tool (5) over the workpiece (9).

### FIELD OF THE INVENTION

The invention relates to a copying apparatus, and in particular, to a copying apparatus for enabling a cutting tool such as a router, to copy a two dimensional or three dimensional pattern from a template onto a workpiece.

### BACKGROUND OF THE INVENTION

Various devices exist for copying patterns such as ornaments, two dimensional patterns, lettering or similar decorations, from a template onto a workpiece. However, existing copying machines tend to be complex devices which are mainly intended for industrial use. GB1,395,834 discloses a typical copying machine, having a complicated mechanical arrangement for reproducing the shape of a pattern on a workpiece. Despite, being relatively complex, GB1,395,834 is only suitable for reproducing two dimensional patterns.

Copying machines for reproducing three dimensional patterns tend to be even more complex, since the cutting tool must be capable of moving vertically in order to follow the contours of the pattern being copied. WO86/02864 is an example of a three dimensional copying machine which, although claiming to be a simple device, is still too complex and expensive for semi-professional or “do-it-yourself” use.

The aim of the present invention is to provide a copying apparatus for enabling a tool to copy a two dimensional or three dimensional pattern from a template onto a workpiece, without having the above mentioned disadvantages associated with the prior art.

### SUMMARY OF THE INVENTION

According to the present invention, there is provided apparatus for enabling a tool to reproduce a pattern from a template on a workpiece, the apparatus comprising:

a first support mechanism which supports the tool in a spaced relationship with a pattern follower;

a second support mechanism which supports the template and the workpiece in a spaced relationship with one another, the first and second support mechanisms being brought together in use such that the pattern follower overlies the pattern on the template and the tool overlies the workpiece;

wherein the first support mechanism and the second support mechanism are not connected to one another.

As the tool is held in a spaced relationship with the pattern follower and the template is held in spaced relationship with the workpiece, movement of the follower as it follows the pattern on the template produces an identical movement of the tool over the workpiece.

Preferably, the first support mechanism comprises:

a carrier for supporting the tool;

a follower arm for supporting the pattern follower; and

a linkage for connecting the carrier and follower in a spaced relationship.

Preferably, the linkage comprises adjusting means for adjusting the spacing between the follower arm and the carrier.

Preferably the carrier comprises a plurality of attachment holes and/or brackets for securing different types of tool. Some of the holes may be threaded, so that the tool can be bolted directly to the carrier.

Preferably the second support mechanism comprises:

a base;

a table for supporting the template; and

a second linkage for connecting the table and base in a spaced relationship.

Preferably, the second linkage comprises adjusting means for adjusting the spacing between the table and the base.

Preferably, the template is positioned above, and spaced away from the workpiece, and the pattern follower is positioned above, and spaced away from the tool. Preferably, the pattern follower lies on a rotary axis of the tool.

Preferably the shape of the pattern follower is chosen in accordance with the pattern being copied.

Preferably the tool is a rotary cutting tool such as a router.

Preferably the shape of the cutting bit of the router is the same as the shape of the pattern follower.

Preferably the first support mechanism further comprises a counterbalance for counterbalancing at least a part of the weight of the first support mechanism and/or the tool. Preferably, the counterbalance is attached to the follower arm via a pulley system. Preferably, the follower arm comprises an adjustable bracket for attachment of the counterbalance. Preferably, the pulley system is supported by a third support mechanism.

Preferably, the pattern follower is adjustably mounted in the follower arm. Alternatively, or in addition, the pattern follower may be slidably received in the follower arm, so that in use of the device, the pattern follower can only apply minimal pressure to the template, if it comes into contact with it during use. Such an embodiment also has the advantage that the pattern follower can be adjusted, so that it actually contacts the pattern on the template and thereby allows more accurate tracking of the pattern by the pattern follower. Furthermore, damage to the pattern or to the template is prevented, if the support table is slightly misaligned relative to the workpiece.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 shows a copying apparatus according to a first embodiment of the invention;

FIG. 2 shows the first support mechanism of FIG. 1 in greater detail;

FIG. 3 shows a copying apparatus according to a second embodiment of the invention;

FIGS. 4 and 5 show how a cutting tool is attached and aligned in the first support mechanism shown in FIG. 2;

FIGS. 6a to 6e show examples of pattern followers that may be used in the copying apparatus of FIGS. 1 and 3.

### DETAILED DESCRIPTION OF PREFERRED EMBODIMENTS OF THE

### PRESENT INVENTION

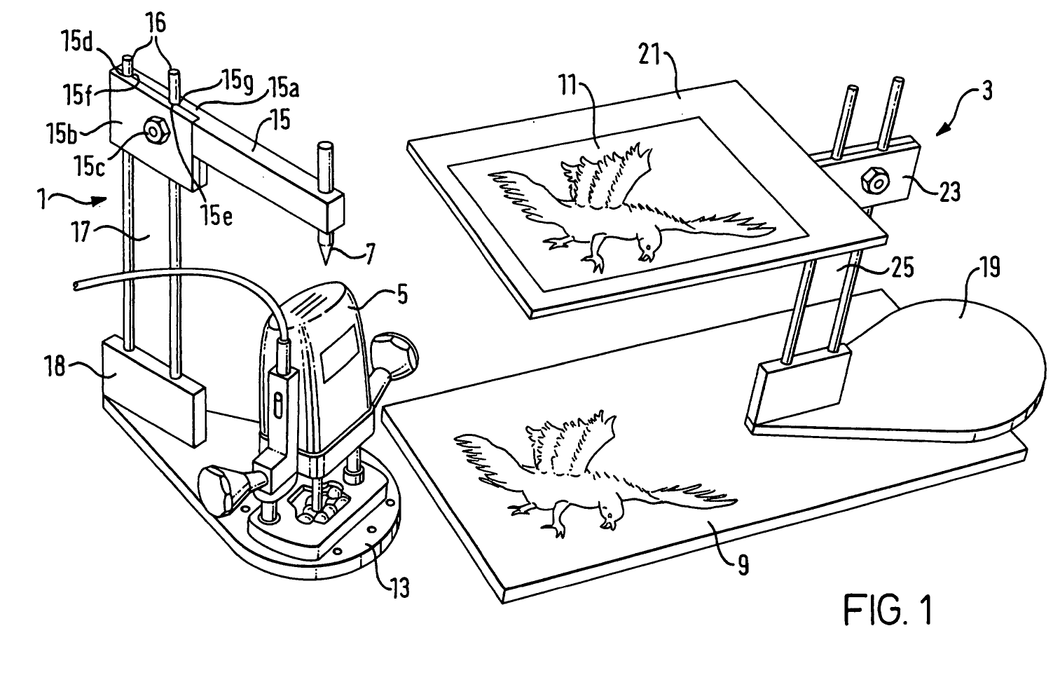

FIG. 1 shows a perspective view of a first embodiment of the present invention. The illustrated copying apparatus comprises a first support mechanism 1 and a second support mechanism 3. The first support mechanism 1 supports a tool, for example a router 5, in a spaced relationship with a pattern follower 7. The second support mechanism 3 is arranged for supporting a workpiece 9 in a spaced relationship with a template 11.

The first support mechanism 1 comprises a carrier 13 for supporting the router 5 and a follower arm 15 for supporting the pattern follower 7. The carrier 13 and the follower arm 15 are connected to one another by a linkage 17 which, as mentioned above, is arranged to support the pattern follower 7 in a spaced relationship with the router 5.

The linkage 17, in the illustrated embodiment, comprises a pair of spaced apart, parallel rods 16 which are mounted in openings formed in a boss 18 on the carrier 13. The follower arm 15 is provided with a recessed portion 15a in its end remote from the pattern follower 7 and a clamping plate 15b which is located in the recessed portion 15a. A bolt passes through the clamping plate 15b and the follower arm 15 and is received in a nut 15c. Pairs of spaced apart grooves 15d, 15e and 15f, 15g are provided in the adjacent faces of the recessed portion 15a and the clamping plate 15b and are aligned to define openings which receive the rods 16.

The height of the pattern follower 7 above the carrier 13 is adjustable using the linkage 17, as described below. This allows the copying apparatus to be used with different types of routers 5.

Preferably, the pattern follower 7 is supported by the follower arm 15, directly above the cutting bit of the router 5, so that the pattern follower 7 lies substantially on the rotational axis of the cutting bit of the router 5.

The second support mechanism 3 comprises a base 19 for supporting the workpiece 9, and a table 21 for supporting the template 11. The table 21 is supported by an arm 23 which is adjustably connected to the base 19 via a linkage 25 which is identical to the linkage 17, described above.

Preferably, the template 11 is arranged so that it is located directly above the workpiece 9. The linkage 25 allows the height of the table 21 to be adjusted above the workpiece 9.

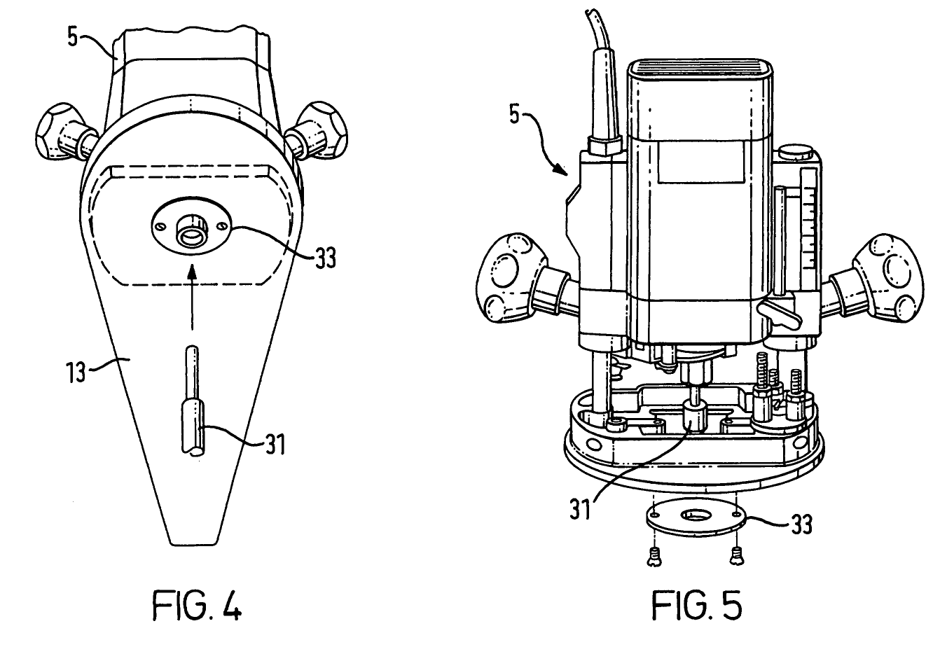

In use of the copying apparatus, the template to be copied is first attached to the table 21, and the workpiece 9 is attached to the base 19 of the second support member 3. The router 5 is attached to the carrier 13 (as will be described in greater detail with reference to FIGS. 4 and 5 below) and the height of pattern follower 7 above the carrier 13 is then adjusted by loosening the nut 15c and sliding the follower arm 15 up or down the rods 16 to the desired position. The nut and bolt are then tightened, thereby trapping the rods 16 between the clamping plate 15b and the recessed portion 15a of the follower arm 15 and fixing the height of the follower arm 15 from the carrier 13.

The height of the table 21 above the workpiece 9 is then adjusted by adjusting the linkage 25 in the same way as the linkage 17 of the first support mechanism 1 is adjusted. The height of the table 21 is adjusted such that with the pattern follower 7 just contacting the pattern formed on the template 11 the cutting bit of the router 5 is just clear of the workpiece 9.

The user clasps the router 5 in the normal manner, plunges the bit of the router 5 into the workpiece and then moves the pattern follower 7 over the pattern formed on template 11 such that the cutting bit of the router 5 reproduces the pattern on the workpiece 9. In this particular embodiment, the pattern follower 7 is slidably received in the follower arm 15, such that the pattern follower rests on the template 11 with minimal pressure, and is allowed to rise or fall in the follower arm if the support table 21 is slightly misaligned relative to the workpiece 9.

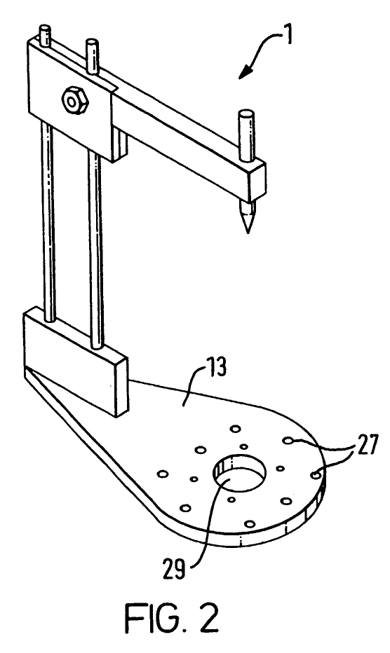

FIG. 2 shows a more detailed view of the first support mechanism 1, and in particular of the carrier 13. The carrier 13 comprises a number of attachment holes 27, which are provided to facilitate the attachment of different types of routers 5 to the carrier 13. The attachment holes 27 have the advantage of making the copying apparatus suitable for use with many different types of routers. The carrier 13 has an opening 29, through which the cutting bit of the router 5 projects in use.

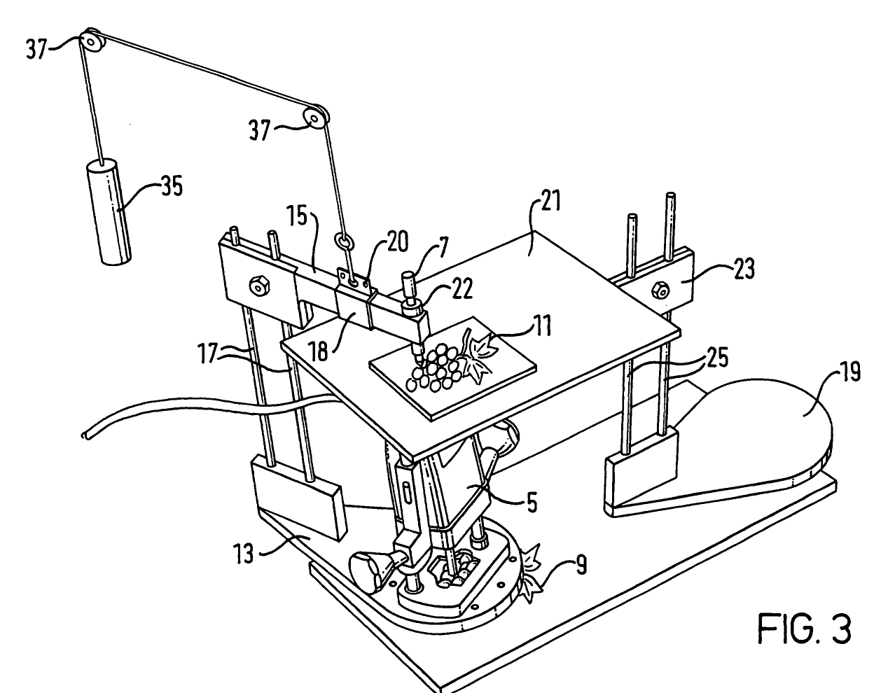

Although the embodiment of FIGS. 1 and 2 is capable of copying both two dimensional and three dimensional objects, it is more suited for copying two dimensional patterns. FIG. 3 shows a second embodiment of the invention, having a counterbalance 35 for assisting in the copying of three dimensional patterns.

The first and second support mechanisms 1, 3 are similar to those previously described in FIG. 1. However, the first support mechanism 1 is connected to a counterbalance 35, preferably via a pulley system 37. The pulley system may be supported by suitable means, such as a third support mechanism (not shown) similar to the first and second support mechanisms 1, 3.

In the illustrated embodiment, the counterbalance 35 is attached to the follower arm 15 by means of a bracket 18 which is slidably mounted to the follower arm 15. The bracket 18 can be located at various positions along the length of the follower arm 15, and facilitates attachment of the counterbalance 35 to the centre of gravity of the first support mechanism and the router 5. The position of the bracket 18 will therefore depend upon the particular type of router 5 which is being used. Once the centre of gravity has been determined, the bracket can be fixed in position using bolts 20 which tighten the bracket against the follower arm 15.

The counterbalance 35 counterbalances the weight of the first support mechanism 1 and the router 5 and makes it easier for the user to lift the router 5 when following a three dimensional pattern on the template 11.

In the illustrated embodiment, the pattern follower 7 has an external thread and is located in a threaded bore formed through the follower arm 15. The height of the pattern follower 7 in the follower arm 15 is fixed using a threaded nut 22 which is engaged on the thread of the pattern follower 7 and may be tightened against the follower arm 15 to lock the pattern follower 7 in position. In use of the copying apparatus for copying three dimensional patterns, the router is set such that the cutting bit is positioned so that it is fixed in a position proud of the base of the router at all times, and the pattern follower 7 is positioned in the follower arm 15 so that it is set to the highest cutting height of the three dimensional pattern 11. The pattern follower 7 is then moved over the pattern 11, such that the router 5 makes an initial cut in the workpiece 9.

The position of the pattern follower 7 in the follower arm 15 is then adjusted to a lower cutting position. As before, the pattern follower 7 is moved over the pattern 11 so that the router 5 cuts the workpiece 9 at this lower cutting position. The steps of lowering the position of the pattern follower 7 and tracing the pattern follower 7 over the pattern 11 continues until the deepest cut has been made.

Reference will now be made to FIGS. 4 and 5, which describe how the router 5 is mounted and aligned in the carrier 13.

Prior to attachment of the router 5 to the carrier 13, a line-up pin 31 is inserted in the router 5 where the cutting bit normally resides and a line-up bush 33 is connected to the carrier 13. The router 5 is then brought into contact with the carrier, such that the line-up pin 31 is aligned in the aperture of the line-up bush 33. While in this position, the router 5 is fixed to the carrier 13 using the appropriate attachment holes 27. This alignment procedure ensures that the router 5 is correctly located in the carrier 13. Before using the copying apparatus, the line-up pin 31 is removed, and replaced with an appropriate bit.

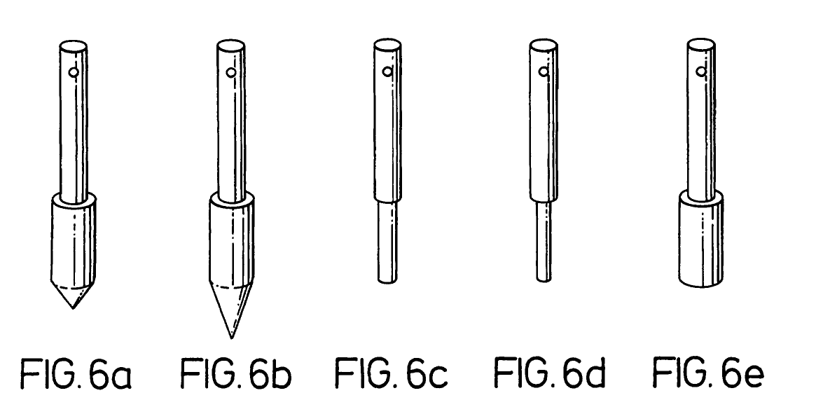

FIGS. 6a to 6e show different types of pattern followers 7 which can be chosen to suit a particular template 11. For example, pattern follower 6b can be for applications requiring detailing routing work using a fine cutting bit.

Although the preferred embodiments have been described using routers as the cutting tool, it will be appreciated that the invention is equally applicable to other tools, such as milling or grinding tools.

It is noted that the preferred embodiments show the pattern follower 7 arranged directly above the router 5, and the template 11 directly above the workpiece 9. However, it will be appreciated that other fixed relationships are possible, provided the fixed relationship between the pattern follower 7 and the router 5 is the same as the fixed relationship between the template 11 and the workpiece 9.

Furthermore, although the second support mechanism 3 is shown as having the base 19 projecting away from the support table 21, the base 19 could equally project beneath the support table 21, acting as the support for the workpiece. Alternatively, or in addition, the workpiece may be positioned in a frame (not shown), with the frame being attached to the base 19. Furthermore, the support table 21 may have additional support structures provided on the free end of the table if greater stability is required when using the copying apparatus.

The template 11 can comprise any form of pattern, ranging from a simple line drawing or sketch which is to be copied, to a pattern having guiding grooves, to a three dimensional design. Thus, in addition to reproducing a routed version of a line drawing, it is also possible to follow letters or numbers. This allows routed signs to be created.

Furthermore, the pattern being created can be relieved, i.e. the copied image is left standing proud of the remainder of the material. This can be accomplished by using a pattern which is a negative of the image which is requires on the workpiece and following the negative pattern with a suitable pattern follower 7.

The overall dimensions of the copying apparatus can vary so that a small version is used to copy small images, while a large version is used to copy larger images.

Also, while the follower arm 15 has been described as being attached to the linkage 17 by means of a recessed portion 15a in its end remote from the pattern follower 7 and a clamping plate 15b which is located in the recessed portion 15a, it is noted that other suitable methods of attaching the follower arm 15 to the linkage 17 may be used. For example, the follower arm 15 could be formed from two identical halves, each half of the follower arm 15 having pairs of spaced apart grooves 15d, 15e and 15f, 15g provided in the adjacent faces to define openings which receive the rods 16.

Furthermore, in the second embodiment, the height of the pattern follower 7 in the follower arm 15 may be adjusted using suitable means other than the threaded nut 22 described in FIG. 3.

Finally, while the counterbalance has been described as being attached to the first support mechanism by means of a pulley arrangement, it is noted that other mechanisms such as hydraulic arrangements could also be used for this purpose.

1. Apparatus for enabling a tool to reproduce a pattern from a template on a workpiece, the apparatus comprising:
a first support mechanism which supports the tool in a spaced relationship with a pattern follower;
a second support mechanism which supports the template and the workpiece in a spaced relationship with one another, the first and second support mechanisms being brought together in use such that the pattern follower overlies the pattern on the template and the tool overlies the workpiece;
wherein the first support mechanism and the second support mechanism are not connected to one another.

2. Apparatus as claimed in claim 1, wherein the first support mechanism comprises:
a carrier for supporting the tool;
a follower arm for supporting the pattern follower; and
a linkage for connecting the carrier and follower in a spaced relationship.

3. Apparatus as claimed in claim 1 or 2, wherein the linkage comprises adjusting means for adjusting the spacing between the follower arm and the carrier.

4. Apparatus as claimed in any one of the preceding claims, wherein the carrier comprises a plurality of attachment holes for securing different types of tool.

5. Apparatus as claimed in any one of the preceding claims, wherein the second support mechanism comprises:
a base;
a table for supporting the template; and
a second linkage for connecting the table and base in a spaced relationship.

6. Apparatus as claimed in claim 5, wherein the second linkage comprises adjusting means for adjusting the spacing between the table and the base.

7. Apparatus as claimed in any one of the preceding claims, wherein the template is positioned above, and spaced away from the workpiece, and the pattern follower is positioned above, and spaced away from the tool.

8. Apparatus as claimed in claim 7, wherein the pattern follower lies on a rotary axis of the tool.

9. Apparatus as claimed in any one of the preceding claims, wherein the shape of the pattern follower is chosen in accordance with the pattern being copied.

10. Apparatus as claimed in any one of the preceding claims, wherein the tool is a router.

11. Apparatus as claimed in claim 11, wherein the cutting bit of the router is the same shape as the pattern follower.

12. Apparatus as claimed in any one of the preceding claims, wherein the first support mechanism further comprises a counterbalance, for counterbalancing at least a part of the weight of the first support mechanism and/or the tool.

13. Apparatus as claimed in claim 12, wherein the counterbalance is attached to the follower arm via a pulley system.

14. Apparatus as claimed in claim 12 or 13, wherein the follower arm comprises an adjustable bracket for attachment of the counterbalance.

15. Apparatus as claimed in claim 13 or 14, wherein the pulley system is supported by a third support mechanism.

16. Apparatus substantially as described herein, with reference to and as shown in the accompanying drawings.
